(19) United States
(12) Patent Application Publication
(10) Pub. No.: US 2019/0269135 A1
(43) Pub. Date: Sep. 5, 2019

(54) TERNARY HERBICIDAL COMBINATION

(71) Applicant: UPL LTD, Haldia, West Bengal (IN)

(72) Inventors: Vishwanath Bhanudas GADE, Mumbai, Maharashtra (IN); Jaidev Rajnikant SHROFF, Dubai (AE); Vikram Rajnikant SHROFF, Dubai (AE)

(21) Appl. No.: 16/348,563

(22) PCT Filed: Oct. 25, 2017
(86) PCT No.: PCT/IB2017/056614

§ 371 Date: May 9, 2019

(30) Foreign Application Priority Data
Nov. 9, 2016 (IN) 201631038240

(51) Int. Cl. A01N 43/80; A01N 37/12; A01N 47/36

(52) U.S. Cl. CPC A01N 43/80; A01N 47/36; A01N 37/12

(57) ABSTRACT

A herbicidal combination comprising (A) clomazone; (B) 2,4-D or its derivatives; and (C) pyrazosulfuron or its derivatives, a composition comprising this combination and method of controlling weeds in sugarcane using this combination or composition is disclosed.

### FIELD OF THE INVENTION

The present invention relates to a combination comprising clomazone; 2,4-D and its derivatives; and pyrazosulfuron ethyl; and compositions thereof; especially for selective control of weeds in sugarcane.

### BACKGROUND AND PRIOR ART

Weeds cause 12 to 72% reduction in sugarcane yield depending upon the density of the weeds. The weed problem in sugarcane is further compounded due to the nature and practices in sugarcane cultivation. Sugarcane is planted with a wide row spacing, which provides more space for the weeds to flourish. The growth of sugarcane in the initial stages is very slow as it takes about 15 to 20 days to complete the germination and another 60-75 days for developing the full canopy cover. During this 30-120 days period, the weeds get plenty of time to compete with sugarcane crop for nutrients, soil moisture, sunlight right from germination to growing stage and suppresses its growth and development. Sugarcane is also grown under abundant water and nutrient supply conditions, which encourages the weed infestation. Sugarcane cultivation also involves very little preparatory tillage. Therefore, the weeds once established tend to flourish well, which is further compounded due to the use of fertilizers.

Sugarcane is usually grown throughout the year. Therefore, it is also prone to being infested with a variety of weeds. The types of weeds which grow in sugarcane are monocotyledonous weeds of the genera: Echinochloa, Setaria, Panicum, Eleusine, Digitaria, Phleum, Cenchrus. Poa, Festuca, Eleusine, Brachiaria, Lolium, Bromus, Avena, Cyperus, Sorghum, Agropyron, Cynodon, Monochoria, Fimbristylis, Sagittaria, Eleocharis, Paspalum, Ischaemum, Sphenoclea, Dactyloctenium, Agrostis, Alopecurus, Apera, etc; Dicotyledonous weeds of the genera: Sinapis, Lepidium, Galium, Stellaria, Matricaria, Anthemis, Galinsoga, Commelina, Ageratum, Chenopodium, Urtica, Senecio, Euphorbia, Acanthospermum, Amaranthus, Portulaca, Ipomoea, Xanthium, Convolvulus, Ipomoea, Polygonum, Sesbania, Ambrosia, Cirsium, Carduus, Sonchus, Solanum, Rorippa, Rotala, Lindemia, Lamium, Veronica, Abutilon, Emex, Datura, Viola, Galeopsis, Papaver, Centaurea, Trifolium, Ranunculus, Taraxacumetc; Additionally, Cyperus, Scirpus, etc. among sedges are major weeds found in sugarcane.

Therefore, it is difficult to achieve weed control in sugarcane by following hand weeding or a specific weed management approach. It is therefore advisable to have a suitable combination of herbicides for more dependable, economical and desirable weed control.

Some common herbicides currently used for weed management in sugarcane are atrazine, oxyfluorfen, grammaxone+2,4-D, glyphosate and thiobencarb. Unfortunately, most of the available herbicides can control either one type of weeds i.e. either monocotyledonous weeds or dicotyledonous weeds. Moreover most of the herbicides do not protect the germination of weeds after killing of standing weeds therefore new weeds again emerge and start competing against the sugarcane. Moreover, the use of 2,4-D is discouraged when the neighbouring crop is cotton or okra. Thus, there is a need to find alternate herbicidal solutions for controlling the weed infestations in sugarcane.

Clomazone is a herbicide having the IUPAC name 2-(2-chlorobenzyl)-4,4-dimethyl-1,2-oxazolidin-3-one and structure:

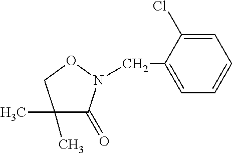 [SMILES: CC1(C)CON(Cc2ccccc2Cl)C1=O]

Pyrazosulfuron-ethyl is a pyrimidinylsulfonyl urea herbicide having IUPAC name ethyl 5-[(4,6-dimethoxypyrimidin-2-ylcarbamoyl)sulfamoyl]-1-methylpyrazole-4-carboxylate:

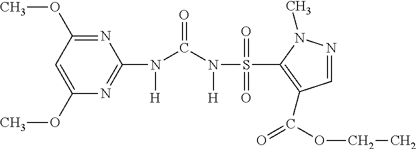 [SMILES: CCOC(=O)c1cnn(C)c1S(=O)(=O)NC(=O)Nc1nc(OC)cc(OC)n1]

It is a rice herbicide belonging to the sulfonylurea group of herbicides. It has eminent activity against a broad spectrum of annual and perennial rice paddy weeds, especially broadleaf weeds and sedges, with pre-emergence and early post-emergence applications at extremely low use rates.

2,4, D is a phenoxyacetic herbicide having IUPAC name as (2,4-dichlorophenoxy)acetic acid:

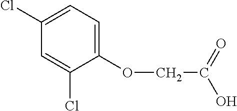 [SMILES: O=C(O)COc1ccc(Cl)cc1Cl]

US2016106101 (A1) discloses a method for improving the growth of target plants at a locus by applying growth-improving amount of clomazone. Target plant is sugarcane, rice, corn, bean, soybean, oilseed rape and potato. Further, the disclosed method comprises applying to the locus one or more other herbicides, insecticides, fungicides, nematocides, plant growth regulators, and/or safeners.

EP0377642 (B1) teaches a combination of herbicides metsulfuron methyl and bensulfuron methyl in a granular formulation for the control of weeds in rice fields. There is a need in the art for enhanced uses including applying a combination of herbicides for improved methods of herbicidal control.

WO2015151088 (A1): Titled “HERBICIDAL MIXTURE OF CAROTENOID BIOSYNTHESIS INHIBITING COMPOUND AND AN AHAS/ALS INHIBITING COMPOUND AND USES THEREOF” Filed by ADAMA AGAN LTD: Discloses a herbicidal mixture for the selective control of weeds and grasses in crops of cultivated plants, comprising a) a herbicide which inhibits carotenoid biosynthesis (clomazone); and b) a herbicide which inhibits the action of ALS/AHAS, or an ester or salt (pyrazosulfuron-ethyl) of any of the foregoing, or a combination thereof.

US2014329681 (A1): titled “METHOD FOR CONTROLLING WEEDS IN SUGAR CANE FIELD” Filed by IKEDA HAJIME discloses a method for controlling weeds in a sugar cane field, comprising applying at least one herbicide selected from the group consisting of ametryn, atrazine, simazine, alachlor, metolachlor, S-metolachlor, asulam, clomazone, trifluralin, pendimethalin, tebuthiuron, diuron, hexazinone, amicarbazone, imazapic, trifloxysulfuron-sodium, iodosulfuron-methyl-sodium, halosulfuron-methyl, ethoxysulfuron, carfentrazone-ethyl, isoxaflutole, bicyclopyrone, mesotrione, picloram and salts and esters thereof, 2,4-D and salts thereof and esters thereof, dicamba and salts and esters thereof, clomazone, MSMA, paraquat, diquat, glufosinate and salts thereof, glufosinate-P and salts thereof, and glyphosate and salts thereof, to a field before or after planting stem cuttings of sugar cane having only one node.

The efficacy of these herbicides against harmful weeds in the crop plants is remarkable, but depends on the application rate, the formulation ingredients, the harmful weeds to be controlled, the climatic conditions and the soil conditions. Single application of the individual herbicide may lead to development of resistance in the target weeds and sometimes such resistance is developed even when a combination of herbicides is applied. In general, however, there remains a need for methods to achieve the herbicidal action at a lower application rate of active compounds. Not only does a lower application rate reduce the amount of an active compound required for application, but, it also reduces the amount of formulation auxiliaries required. It both reduces the economic input and improves the ecological compatibility of the herbicide treatment.

One way to improve the application profile of a herbicide can consist in combining the active compound with one or more other active compounds. However, while formulating one or more herbicides in a single composition, a formulator is faced by many problems such as physical, chemical and biological incompatibility, a lack of stability in a coformulation, decomposition of an active compound, or antagonism of the active compounds.

Therefore there is a need for combinations of active compounds having an advantageous activity profile, high stability and, a synergistically improved action, which allows the application rate to be reduced in comparison with the individual application of the active compounds to be combined.

These and other advantages have been achieved by way of one or more embodiments of the invention described hereinafter.

### SUMMARY OF THE INVENTION

In an aspect, the present invention provides a herbicidal combination comprising (A) a herbicidally effective amount of clomazone; (B) a herbicidally effective amount of 2,4-D or its derivatives; and (C) a herbicidally effective amount of pyrazosulfuron or its derivatives.

In another aspect, the present invention provides a herbicidal composition comprising (A) a herbicidally effective amount of clomazone; (B) a herbicidally effective amount of 2,4-D or its derivatives; and (C) a herbicidally effective amount of pyrazosulfuron or its derivatives along with at least one agrochemically acceptable excipient.

In an embodiment, the present invention provides an improved herbicidal combination for the control of undesired weeds in sugarcane, said combination comprising (A) a herbicidally effective amount of clomazone; and (B) a herbicidally effective amount of 2,4-D or its derivatives; wherein the improvement comprises in said combination additionally comprising (C) a synergistically effective amount of pyrazosulfuron or its derivatives.

In another embodiment, the present invention provides a method for controlling undesired weeds in sugarcane, said method comprising treating the locus at which said sugarcane is growing or is intended to be grown with a herbicidal combination comprising (A) a herbicidally effective amount of clomazone; (B) a herbicidally effective amount of 2,4-D or its derivatives; and (C) a herbicidally effective amount of pyrazosulfuron or its derivatives.

### DETAILED DESCRIPTION OF THE INVENTION

Surprisingly, the present inventors have now found that when the combination of clomazone and 2,4-D was mixed with a reduced amount of pyrazosulfuron ethyl, the resultant combination showed improved synergistic effect. It was surprising that even a reduced amount of pyrazosulfuron-ethyl, which is a conventional rice herbicide, resulted in unexpectedly enhancing the efficacy of a combination of clomazone and 2,4-D, to a greater degree than expectable, for controlling undesired weeds in sugarcane.

Surprisingly, it has been found that the active compound combinations or compositions according to the invention do not only exhibit an additive effect of the activity of the individual components, but exert a synergistic effect when used in combination. Therefore, firstly, the customary application rates of the individual substances were reduced.

Therefore, in an aspect, the present invention provides herbicidal combination comprising (A) a herbicidally effective amount of clomazone; (B) a herbicidally effective amount of 2,4-D or its derivatives; and (C) a herbicidally effective amount of pyrazosulfuron or its derivatives.

In an embodiment, the herbicides or the combinations thereof contemplated according to the present invention may be pre-formulated and may be in the form of granules, which may be Water Dispersible Granules (WDG) or Granules (G) for broadcasting, Wettable Powders, Suspension Concentrates, Emulsifiable Concentrate, Suspoemulsions, Microemulsions. Capsule Suspensions etc. However, the choice of any preferred formulation type is not particularly limiting.

Adjuvants and ancillary ingredients may be used to formulate such pre formulated compositions and may employ wetting agents, adhesives, dispersants, penetrants, rain-fastening agents or surfactants and, if appropriate, solvent or oil and other agriculturally acceptable additives and adjuvants.

Therefore, in another aspect, the present invention provides a herbicidal composition comprising (A) a herbicidally effective amount of clomazone; (B) a herbicidally effective amount of 2,4-D or its derivatives; and (C) a herbicidally effective amount of pyrazosulfuron or its derivatives along with agrochemically acceptable excipients.

The compound 2,4-D or its derivatives shall include the compound 2,4-dichlorophenoxyacetic acid per se or any its derivatives including 2,4-D-ammonium; 2,4-D-butotyl: 2,4-D-2-butoxypropyl; 2,4-D-3-butoxypropyl; 2,4-D-butyl; 2,4-D-diethylamine: 2,4-D-dimethylamine; 2,4-D-diolamine; 2,4-D-dodecylamine; 2,4-D-ethyl; 2,4-D-2-ethylhexyl; 2,4-D-heptylamine; 2,4-D-isooctyl; 2,4-D-isopropyl: 2,4-D-isopropylamine; 2,4-D-lithium; 2,4-D-meptyl; 2,4-D-methyl; 2,4-D-octyl; 2,4-D-pentyl; 2,4-D-propyl; 2,4-D-sodium; 2,4-D-tefuryl; 2,4-D-tetradecylamine; 2,4-D-triethylamine; 2,4-D-tris(2-hydroxypropyl)amine; 2,4-D-trolamine and 2,4-D-choline.

In an embodiment, the preferred 2,4-D derivative is 2,4-D sodium.

The compound pyrazosulfuron or its derivatives shall include the compound 5-[(4,6-dimethoxypyrimidin-2-ylcarbamoyl)sulfamoyl]-1-methylpyrazole-4-carboxylic acid or an agriculturally acceptable salt or ester or a carboxylate salt thereof, including but not limited to, pyrazosulfuron-ethyl.

In an embodiment, the preferred pyrazosulfuron derivative is pyrazosulfuron-ethyl.

In an embodiment, clomazone is present within the compositions in an amount of 5% to 70% by total weight of the composition.

In another embodiment, 2,4-D or its derivative is present within the compositions in an amount of 10% to 70% by total weight of the composition.

It has been one of the surprising findings of the present invention that when the combination of clomazone and 2,4-D was mixed with a reduced amount of pyrazosulfuron-ethyl, the resultant combination showed improved synergistic effect. It was surprising that even a reduced amount of pyrazosulfuron-ethyl, which is a conventional rice herbicide, resulted in unexpectedly enhancing the efficacy of a combination of clomazone and 2,4-D, to a greater degree than expectable, for controlling undesired weeds in sugarcane.

Thus, in this embodiment, the present invention provides an improved herbicidal combination for the control of undesired weeds in sugarcane, said combination comprising (A) a herbicidally effective amount of clomazone; and (B) a herbicidally effective amount of 2,4-D or its derivatives; wherein the improvement comprises said combination additionally comprising (C) a synergistically effective amount of pyrazosulfuron or its derivatives.

The term synergistically effective amount of pyrazosulfuron or its derivatives means an amount of 0.1% to 5% by total weight of the composition.

In an embodiment of the present invention, the synergistically effective amount of pyrazosulfuron-ethyl comprises from about 0.1% to about 5% by total weight of the formulation. More preferably, the synergistically effective amount of pyrazosulfuron-ethyl according to the present invention comprise about 0.05% to about 4.0% by weight of pyrazosulfuron-ethyl. Still more preferably, the synergistically effective amount of pyrazosulfuron-ethyl according to the present invention comprise about, or less than about, 1.0% by total weight of the composition.

In an embodiment, the preferred composition according to the present invention is a granular formulation.

Therefore, in this embodiment, the present invention provides a granular formulation comprising:
(A) a herbicidally effective amount of clomazone;
(B) a herbicidally effective amount of 2,4-D or its derivatives;
(C) a herbicidally effective amount of pyrazosulfuron or its derivatives; and
(D) at least one agrochemically acceptable solid inert.

In this embodiment, the granular formulation of the present invention further comprises an agrochemically acceptable inert. These inerts must be agriculturally acceptable and environmentally friendly. Inerts may include such dispersing agents, antifoaming agents, pH modifiers, surfactants, and other fillers which may be added to stabilize the composition.

In an embodiment, the composition of each or any aspect or embodiment described hereinabove comprises at least one dispersing agent, at least one binding agent, at least one wetting agent and optionally at least one defoamer.

In one embodiment, the composition may contain ionic and nonionic dispersing agents to enable disintegration of granules in water with ease, such as salts of polystyrenesulphonic acids, salts of polyvinylsulphonic acids, salts of naphthalenesulphonic acid/formaldehyde condensates, salts of condensates of naphthalenesulphonic acid, phenolsulphonic acid and formaldehyde, modified styrene acrylic copolymer and salts of lignosulphonic acid, polyethylene oxide/polypropylene oxide block copolymers, polyethylene glycol ethers of linear alcohols, reaction products of fatty acids with ethylene oxide and/or propylene oxide, furthermore polyvinyl alcohol, polyvinylpyrrolidone, copolymers of polyvinyl alcohol and polyvinylpyrrolidone and copolymers of (meth)acrylic acid and (meth)acrylic esters, furthermore alkyl ethoxylates and alkylarylethoxylates. The preferred dispersing agents include modified styrene acrylic copolymer.

In an embodiment, the compositions of the present invention comprise at least one wetting agent selected from soaps; salts of aliphatic monoesters of sulphuric acid including but not limited to sodium lauryl sulphate; sulfoalkylamides and salts thereof including but not limited to N-methyl-N-oleoyltaurate Na salt; alkylarylsulfonates including but not limited to alkylbenzenesulfonates; alkylnaphthalenesulfonates and salts thereof and salts of ligninsulfonic acid. In an embodiment, the wetting agent includes a blend comprising an alkali metal salt of alkylnaphthalenesulfonate or an alkali metal salt of ligninsulfonic acid or a combination thereof.

In a preferred embodiment, the composition of the present invention comprises a wetting component comprising a wetting agent selected from an alkali or alkaline earth metal salt of alkyl naphthalenesulfonate or an alkali metal salt of ligninsulfonic acid or a combination thereof.

In an embodiment, the compositions of the present invention comprise at least one antifoaming agent which is usually employed for this purpose in agrochemical compositions. In an embodiment, the preferred antifoaming agents are selected from aqueous emulsion with polysiloxane and emulsifier; silicone oil and magnesium stearate or a suitable combination thereof.

In a preferred embodiment, the present invention provides a method of controlling broad spectrum of weeds at a locus by administering, at the locus where such weeds are growing or expected to emerge, combinations of (A) a herbicidally effective amount of clomazone; (B) a herbicidally effective amount of 2,4-D or its derivatives; and (C) a synergistically effective amount of pyrazosulfuron or its derivatives.

Therefore, in this embodiment, the present invention provides a method for controlling undesired weeds in sugarcane, said method comprising treating the locus at which said sugarcane is growing or is intended to be grown with a herbicidal combination comprising (A) a herbicidally effective amount of clomazone; (B) a herbicidally effective amount of 2,4-D or its derivatives; and (C) a synergistically effective amount of pyrazosulfuron or its derivatives.

In an embodiment, the locus may be the vicinity of any desired crop.

In a preferred embodiment, the desired crop is sugarcane.

In another preferred embodiment, the weed is selected from the group comprising nut sedge (Cyperusrotundus), flat sedge (Cyperusiria), Commelina (Commelina benghalensis), morning glories (Ipomoea spp.), Chinese sprangletop (Leptochloa chinensis) and Creeping grass (Brachiariareptans).

In another embodiment, the herbicidal combination/composition of the present invention was found especially effective against one or more of the following weeds infestations normally seen in sugarcane, such weeds include sedges—Cyprus rotundus; grasses—Cynodondactylon, Sorghum helepense, Panicum spp., Dactyloctemiumaegyptium; broad leaved weeds—Chenapodium album, Convolvulus arvensis L., Amaranthusviridis L., Portulacaoleraceae L., Commmelinabengalensis L. and Trianthemaportulacastrum L. Physalis minima, Digera arvensis.

In another embodiment, the herbicidal combination/composition of the present invention was found especially effective against one or more of the following weeds, which are normally found in sugarcane, namely weeds of the genera: Echinochloa, Setaria, Panicum, Eleusine, Digitaria, Phleum, Cenchrus, Poa, Festuca, Eleusine. Brachiaria, Lolium, Bromus, Avena, Cyperus, Sorghum, Agropyron, Cynodon. Monochoria, Fimbristylis, Sagittaria, Eleocharis, Paspalum, Ischaemum, Sphenoclea, Dactyloctenium, Agrostis, Alopecurus. Apera, etc; Dicotyledonous weeds of the genera: Sinapis, Lepidium, Galium, Stellaria, Matricaria, Anthemis. Galinsoga, Commelina, Ageratum, Chenopodium, Urtica, Senecio, Euphorbia, Acanthospermum, Amaranthus, Portulaca, Ipomoea, Xanthium, Convolvulus, Ipomoea, Polygonum, Sesbania, Ambrosia, Cirsium, Carduus. Sonchus, Solanum, Rorippa, Rotala, Lindemia, Lamium, Veronica, Abutilon, Emex, Datura, Viola, Galeopsis, Papaver, Centaurea, Trifolium, Ranunculus, Taraxacum etc; Additionally, Cyperus, Scirpus, etc. among sedges are major weeds found in sugarcane.

The invention will now be explained in more detail in the following examples that illustrate, but are not intended to limit, the invention.

The invention shall now be described with reference to the following specific examples. It should be noted that the example(s) appended below illustrate rather than limit the invention, and that those skilled in the art will be able to design many alternative embodiments without departing from the scope of the present invention.

### EXAMPLES

### Synergy Studies

Studies were conducted to compare the weed controlling activity of the combination of Clomazone, 2,4-D and Pyrazosulfuron ethyl and compare its observed efficacy with the “expected” efficacy when Clomazone, 2,4-D and Pyrazosulfuron ethyl were used to treat both dicotyledonous and monocotyledonous weeds. Any difference between the observed and “expected” efficacy could be attributed to synergy between the compounds in the control of monocotyledonous weeds. The expected efficacy of a combination of Clomazone, 2,4-D and Pyrazosulfuron ethyl was calculated using the well-established Colby method.

In the Colby method, the expected (or predicted) response of a combination of herbicides is calculated by taking the product of the observed response for each individual component of the combination when applied alone divided by 100 and subtracting this value from the sum of the observed response for each component when applied alone. An unexpected enhancement in efficacy of the combination is then determined by comparing the observed response of the combination to the expected (or predicted) response as calculated from the observed response of each individual component alone. If the observed response of the combination is greater than the expected (or predicted) response, or stated conversely, if the difference between the observed and expected response is greater than zero, then the combination is said to be synergistic or unexpectedly effective. (Colby, S. R., Weeds, 1967(15), p. 20-22) The Colby method requires only a single dose of each herbicide applied alone and the mixture of both doses. The formula used to calculate the expected efficacy (EE) which was compared with the observed efficacy (OE) to determine the efficacy of the present invention is explained hereinbelow:

EE=(B efficacy+A efficacy−(B efficacy×A efficacy)/100)

The weed control activity of the individual herbicides of the invention and their combinations were evaluated on weeds such as DCA=Dactyloctenium aegyptium, EC=Echinochloa colonum, LP=Leptochloa chinensis, AV=Amaranthus viridis, TP=Trianthema portulacastrum, PO=Portulaca oleracea, PM=Physalis minima, DA=Digera arvensis; CR=Cyprus rotundas. The trial was carried out in Randomized Complete Block (RCB) method, all field trials were conducted using this method. Each trial were replicated four times and conducted under GEP guidelines. Application volumes were varied for each mixture. Such field trials were carried out at various locations so as to generate independent data, the locations were chosen randomly. Clomazone, 2,4-D and Pyrazosulfuron ethyl were sprayed according to their recommended dosage.

The following formula was used to calculate the expected activity of mixtures containing three active ingredients, A, B and C:

$$Expected ( E ) A + B + C - \frac{( AB + A C + BC )}{100} + \frac{ABC}{10 \text{,} 000}$$

Where
A=observed efficacy of active ingredient A at the same concentration as used in the mixture.
B=observed efficacy of active ingredient B at the same concentration as used in the mixture.
C=observed efficacy of active ingredient C at the same concentration as used in the mixture.

The herbicide tank mix combinations, application rates, plant species tested, and results are given in the following examples:

### Examples 1: Clomazone, 2,4-D and Pyrazosulfuron ethyl

Field trials were carried out to test the synergy of the combination Clomazone, 2,4-D and Pyrazosulfuron ethyl. The field trials were carried out at various locations in Bulandshahar (UP)-Agota. The percentage efficacy was calculated after 30 days of applications. The target weed was EC=Echinochloa crusgalli, LC=Leptochloa chinensis and and CR=Cyprus rotundas and the results are recorded in the table below.

TABLE 1

| | | % Weed control | | | |
|---|---|---|---|---|---|
| | | EC Weed control | | LC Weed control | |
| Dose | | in sugarcane | | in Sugarcane | |
| | Dose rate | at 30DAA | | at 30 DAA | |
| Active | g/ha | Expected | Actual | Expected | Actual |
| Untreated | | | 0.00 | | 0.00 |
| Check | | | | | |
| 2,4-D ethyl | 2500 | | 2 | | 15 |
| Ester 38% EC | | | | | |
| (950 g) | | | | | |
| Clomazone | 2000 | | 74 | | 84 |
| 50% EC (1000 | | | | | |
| g) | | | | | |
| Pyrazosulfuron | 375 | | 13 | | 38 |
| ethyl 10% WP | | | | | |
| (37.5 g) | | | | | |
| PSE 30 g + | 3000 | 77.83 | 100 | 91.29 | 100 |
| Clomazone | | | | | |
| 730 g + 2,4-D | | | | | |
| 730 g | | | | | |

| Observed—Expected | 22.17 | 8.71 |
|---|---|---|
| efficacy | | |

In the Colby method, the expected (or predicted) response of a combination of herbicides is calculated by taking the product of the observed response for each individual component of the combination when applied alone divided by 100 and subtracting this value from the sum of the observed response for each component when applied alone. An unexpected enhancement in efficacy of the combination is then determined by comparing the observed response of the combination to the expected (or predicted) response as calculated from the observed response of each individual component alone. If the observed response of the combination is greater than the expected (or predicted) response, or stated conversely, if the difference between the observed and expected response is greater than zero, then the combination is said to be synergistic or unexpectedly effective.

Thus, when the combination of the present invention was analyzed using this method, it demonstrated an observed-expected value of greater than zero which is indicative of an unexpected efficacy. The basis of demonstration of unexpected efficacy by comparison with the Colby formula is that herbicide (A) tested alone would kill a proportion of the target weeds and leave the remaining portion (a %) as survivors. Similarly, herbicide B tested alone will leave (b %) as survivors. When combined, A+B will, act independently on the target weed (if unexpected activity is absent); component A leaving a % survivors, which survivors will be controlled by component B; which has an overall effect of a %*b %*100. Subsequently, if the percent control is greater than that predicted by the Colby formula or stated conversely, if the difference between the observed control and the expected control is greater than zero; then unexpected enhancement in activity is acknowledged. The degree to which the difference is greater than zero is not itself critical as long as it is greater than zero; however greater the difference, more significant is the enhancement or the unexpectedness in weed control.

Apart from this synergistic interaction, the role of pyrazosulfuron ethyl was also evaluated using this data. Using the observed efficacies for 2,4-D ethyl and clomazone, the expected efficacy for the combination of 2,4-D ethyl and clomazone (without pyrazosulfuron ethyl) was calculated. This was then compared with the actual efficacy observed in the presence of pyrazosulfuron ethyl.

| | | % Weed control | | | |
|---|---|---|---|---|---|
| | | EC Weed control | | LC Weed control | |
| Dose | | in sugarcane | | in Sugarcane | |
| | Dose rate | at 30DAA | | at 30 DAA | |
| Active | g/ha | Expected | Actual | Expected | Actual |
| Untreated | | | 0.00 | | 0.00 |
| Check | | | | | |
| 2,4-D ethyl | 2500 | | 2 | | 15 |
| Ester 38% EC | | | | | |
| (950 g) | | | | | |
| Clomazone | 2000 | | 74 | | 84 |
| 50% EC (1000 | | | | | |
| g) | | | | | |
| Pyrazasulfuron | 375 | | 13 | | 38 |
| ethyl 10% WP | | | | | |
| (37.5 g) | | | | | |
| Expected | 2500 + | 74.52 | — | 86.40 | — |
| efficacy of 2,4- | 2000 | | | | |
| D and | | | | | |
| clomazone | | | | | |
| (without | | | | | |
| pyrazosulfuron | | | | | |
| ethyl) | | | | | |
| Actual | 3000 | — | 100 | — | 100 |
| observed | | | | | |
| efficacy of 2,4- | | | | | |
| D and | | | | | |
| clomazone | | | | | |
| with | | | | | |
| pyrazosulfuron | | | | | |
| ethyl) | | | | | |

| | | |
|---|---|---|
| Difference between expected | 25.48 | 13.60 |
| efficacy without | | |
| pyrazosulfuron ethyl and | | |
| actual observed efficacy with | | |
| pyrazosulfuron ethyl | | |

It was thus found that when the combination of clomazone and 2,4-D was mixed with a reduced amount of pyrazosulfuron ethyl, the resultant combination showed improved synergistic effect, with and without added pyrazosulfuron ethyl. It was surprising that even a reduced amount of pyrazosulfuron-ethyl, which is a conventional rice herbicide, resulted in unexpectedly enhancing the efficacy of a combination of clomazone and 2,4-D, to a greater degree than expectable, for controlling undesired weeds in sugarcane.

### Example 2

A second set of trials were carried out to test the synergy of the combination Clomazone, 2,4-D and Pyrazosulfuron ethyl. The field trials were carried out at various locations in Bulandshahar (UP)-Agota. The percentage efficacy was calculated after 30 days of applications. The target weed was EC=Echinochloa crusgalli, LC=Leptochloa chinensis and and CR=Cyprus rotundas and the results are recorded in the table below:

| | | % Weed control | | | |
|---|---|---|---|---|---|
| | | EC Weed control | | Sedges (CR) Weed | |
| Dose | | in sugarcane | | control in Sugarcane | |
| | Dose rate | at 30DAA | | at 30 DAA | |
| Active | g/ha | Expected | Actual | Expected | Actual |
| Untreated | | | 0.00 | | 0.00 |
| Check | | | | | |
| 2,4-D ethyl | 2500 | | 7 | | 62 |
| Ester 38% EC | | | | | |
| (950 g) | | | | | |
| Clomazone | 2000 | | 67 | | 11 |
| 50% EC (1000 | | | | | |
| g) | | | | | |
| Pyrazosulfuron | 375 | | 25 | | 67 |
| ethyl 10% WP | | | | | |
| (37.5 g) | | | | | |
| PSE 30 g + | 3000 | 76.98 | 93 | 88.83 | 94 |
| Clomazone | | | | | |
| 730 g + 2,4-D | | | | | |
| 730 g | | | | | |

| | | |
|---|---|---|
| Observed—Expected | 16.02 | 5.17 |
| efficacy | | |

It was thus concluded by the difference in observed versus expected efficacy being greater than zero that this combination of pyrazosulfuron ethyl, clomazone and 2,4-D was synergistic.

Apart from this synergistic interaction, the role of pyrazosulfuron ethyl was also evaluated using this data. Using the observed efficacies for 2,4-D ethyl and clomazone, the expected efficacy for the combination of 2,4-D ethyl and clomazone (without pyrazosulfuron ethyl) was calculated. This was then compared with the actual efficacy observed in the presence of pyrazosulfuron ethyl.

| | | % Weed control | | | |
|---|---|---|---|---|---|
| | | EC Weed control | | LC Weed control | |
| Dose | | in sugarcane | | in Sugarcane | |
| | Dose rate | at 30DAA | | at 30 DAA | |
| Active | g/ha | Expected | Actual | Expected | Actual |
| Untreated | | | 0.00 | | 0.00 |
| Check | | | | | |
| 2,4-D ethyl | 2500 | | 7 | | 62 |
| Ester 38% EC | | | | | |
| (950 g) | | | | | |
| Clomazone | 2000 | | 67 | | 11 |
| 50% EC (1000 | | | | | |
| g) | | | | | |
| Pyrazosulfuron | 375 | | 25 | | 67 |
| ethyl 10% WP | | | | | |
| (37.5 g) | | | | | |
| Expected | 2500 + | 69.31 | — | 66.18 | — |
| efficacy of 2,4- | 2000 | | | | |
| D and | | | | | |
| clomazone | | | | | |
| (without | | | | | |
| pyrazosulfuron | | | | | |
| ethyl) | | | | | |
| Actual | 3000 | — | 93 | — | 94 |
| observed | | | | | |
| efficacy of 2,4- | | | | | |
| D and | | | | | |
| clomazone | | | | | |
| with | | | | | |
| pyrazosulfuron | | | | | |
| ethyl) | | | | | |

| | | |
|---|---|---|
| Difference between expected | 23.69 | 27.82 |
| efficacy without | | |
| pyrazosulfuron ethyl and | | |
| actual observed efficacy with | | |
| pyrazosulfuron ethyl | | |

It was thus found that when the combination of clomazone and 2,4-D was mixed with a reduced amount of only up to 5% of pyrazosulfuron ethyl, the resultant combination showed improved synergistic effect, with and without added pyrazosulfuron ethyl. It was surprising that even a reduced amount of pyrazosulfuron-ethyl only up to about 5%, which is a conventional rice herbicide, resulted in unexpectedly enhancing the efficacy of a combination of clomazone and 2,4-D, to a greater degree than expectable, for controlling undesired weeds in sugarcane.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A herbicidal combination comprising (A) clomazone; (B) 2,4-D or its derivatives; and (C) pyrazosulfuron or its derivatives.

2. The combination as claimed in claim 1, wherein the 2,4-D or its derivatives are selected from the group consisting of 2,4-dichlorophenoxyacetic acid; 4-D-ammonium; 2,4-D-butotyl; 2,4-D-2-butoxypropyl; 2,4-D-3-butoxypropyl; 2,4-D-butyl; 2,4-D-diethylamine; 2,4-D-dimethylamine; 2,4-D-diolamine; 2,4-D-dodecylamine; 2,4-D-ethyl; 2,4-D-2-ethylhexyl; 2,4-D-heptylamine; 2,4-D-isooctyl; 2,4-D-isopropyl; 2,4-D-isopropylamine; 2,4-D-lithium; 2,4-D-meptyl; 2,4-D-methyl; 2,4-D-octyl; 2,4-D-pentyl; 2,4-D-propyl; 2,4-D-sodium; 2,4-D-tefuryl; 2,4-D-tetradecylamine; 2,4-D-triethylamine; 2,4-D-tris(2-hydroxypropyl)amine; 2,4-D-trolamine and 2,4-D-choline.

3. The combination as claimed in claim 1, wherein the pyrazosulfuron or its derivatives are selected from the group consisting of pyrazosulfuron and pyrazosulfuron-ethyl.

4. The herbicidal composition of claim 1, further comprising an agrochemically acceptable excipients.

5. The herbicidal composition as claimed in claim 4, in the form of a granular formulation.

6. The herbicidal composition as claimed in claim 5, comprising about about 1.0% pyrazosulfuron-ethyl by total weight of the composition.

7. The herbicidal composition as claimed in claim 4, further comprising at least one dispersing agent, at least one binding agent, at least one wetting agent, or at least one defoamer.

8. A method for controlling an undesired weeds in sugarcane, said method comprising treating a locus at which said sugarcane is growing or is intended to be grown with an herbicidal combination comprising (A) a herbicidally effective amount of clomazone; (B) a herbicidally effective amount of 2,4-D or its derivatives; and (C) a synergistically effective amount of pyrazosulfuron or its derivatives.

9. The method as claimed in claim 8, wherein the herbicidal combination comprises less than about 1.0% pyrazosulfuron-ethyl by total weight of the composition.

10. The method as claimed in claim 9, wherein said weed is selected from the genera consisting of Echinochloa, Setaria, Panicum, Eleusine, Digitaria, Phleum, Cenchrus, Poa, Festuca, Eleusine, Brachiaria, Lolium, Bromus, Avena, Cyperus, Sorghum, Agropyron, Cynodon, Monochoria, Fimbristylis, Sagittaria, Eleocharis, Paspalum, Ischaemum, Sphenoclea, Dactyloctenium, Agrostis, Alopecurus, Apera; Dicotyledonous weeds of the genera: Sinapis, Lepidium, Galium, Stellaria, Matricaria, Anthemis, Galinsoga, Commelina, Ageratum, Chenopodium, Urtica, Senecio, Euphorbia, Acanthospermum, Amaranthus, Portulaca, Ipomoea, Xanthium, Convolvulus, Ipomoea, Polygonum, Sesbania, Ambrosia, Cirsium, Carduus, Sonchus, Solanum, Rorippa, Rotala, Lindernia, Lamium, Veronica, Abutilon, Emex, Datura, Viola, Galeopsis, Leptochloa, Papaver, Centaurea, Trifolium, Ranunculus, Taraxacum; Cyperus, and Scirpus.
